(19) United States
(12) Patent Application Publication
(10) Pub. No.: US 2025/0269653 A1
(43) Pub. Date: Aug. 28, 2025

(54) FILTER UNIT, LIQUID FLOW DEVICE, AND LIQUID EJECTION APPARATUS

(71) Applicant: SEIKO EPSON CORPORATION, Tokyo (JP)

(72) Inventors: Masahiro KARASAWA, MATSUMOTO-SHI (JP); Kazutoshi SHIMIZU, OKAYA-SHI (JP); Hiromichi NAKASHIMA, MATSUMOTO-SHI (JP); Yoshiaki KISHII, SHIOJIRI-SHI (JP)

(21) Appl. No.: 19/062,326

(22) Filed: Feb. 25, 2025

(30) Foreign Application Priority Data
Feb. 28, 2024 (JP) 2024-028312

(51) Int. Cl. B41J 2/175

(52) U.S. Cl. CPC B41J 2/17563; B41J 2/17596

(57) ABSTRACT

A filter unit attachable to and detachable from an upstream coupling portion and a downstream coupling portion includes: a filter configured to filter liquid; a filter chamber including a pre-filter chamber and a post-filter chamber that are partitioned by the filter; an introduction flow path through which the liquid is introduced into the pre-filter chamber through an introduction port; and a first lead-out flow path through which the liquid is led out from the post-filter chamber through a first lead-out port, wherein when the filter unit is in a state of being attached to the upstream coupling portion and the downstream coupling portion, the introduction port is located in a lowermost portion of the pre-filter chamber, the first lead-out port is located in an uppermost portion of the post-filter chamber, and the pre-filter chamber has a bottom surface inclined upward from the location of the introduction port.

The present application is based on, and claims priority from JP Application Serial Number 2024-028312, filed Feb. 28, 2024, the disclosure of which is hereby incorporated by reference herein in its entirety.

### BACKGROUND

### 1. Technical Field

The present disclosure relates to a filter unit, a liquid flow device, and a liquid ejection apparatus.

### 2. Related Art

For example, as disclosed in Japanese Patent Application Laid-Open No.2006-248058, a filter unit includes a filter, a first ink chamber which is an example of a pre-filter chamber, and a second ink chamber which is an example of a post-filter chamber. Ink flows into the first ink chamber through an ink chamber inlet which is an example of an introduction port. The ink chamber inlet is located in an upper portion of the first ink chamber. The ink that has flowed into the first ink chamber passes through the filter and flows into the second ink chamber. The ink in the second ink chamber flows out through an ink chamber outlet, which is an example of a lead-out port, into an ink outflow path. The ink outflow path extends downward from the second ink chamber.

In the filter unit disclosed in Japanese Patent Application Laid-Open No. 2006-248058, the ink that has flowed in from above and passes through the filter flows out downward. Therefore, there is a concern that bubbles may remain when the filter unit is filled with liquid.

### SUMMARY

A filter unit to solve the problem described above is attachable to and detachable from an upstream coupling portion and a downstream coupling portion located above the upstream coupling portion in a vertical direction, an includes: a filter configured to filter liquid; a filter chamber including a pre-filter chamber and a post-filter chamber that are partitioned by the filter; an introduction flow path through which the liquid is introduced into the pre-filter chamber through an introduction port; and a lead-out flow path through which the liquid is led out from the post-filter chamber through a lead-out port, wherein when the filter unit is in a state of being attached to the upstream coupling portion and the downstream coupling portion, the introduction port is located in a lowermost portion of the pre-filter chamber, the lead-out port is located in an uppermost portion of the post-filter chamber, and the pre-filter chamber has a bottom surface inclined upward from the location of the introduction port.

A liquid flow device to solve the problem described above includes: the filter unit having the above configuration; the upstream coupling portion; the downstream coupling portion; an upstream flow path coupled to the upstream coupling portion; and a downstream flow path coupled to the downstream coupling portion.

A liquid ejection apparatus to solve to the problem described above includes: the liquid flow device having the above configuration; and a liquid ejection unit configured to eject liquid.

### BRIEF DESCRIPTION OF THE DRAWINGS

FIG. 1 is a schematic view of a liquid ejection apparatus of a first embodiment.

FIG. 2 is a schematic cross-sectional view of a filter unit of the first embodiment.

FIG. 3 is a cross-sectional view taken along line 3-3 with arrows in FIG. 2.

FIG. 4 is a schematic cross-sectional view of a filter unit of a second embodiment.

FIG. 5 is a schematic cross-sectional view of a filter unit of a third embodiment.

FIG. 6 is a schematic cross-sectional view of a filter unit of a fourth embodiment.

FIG. 7 is a cross-sectional view taken along line 7-7 with arrows in FIG. 6.

FIG. 8 is a schematic cross-sectional view of a filter unit of a fifth embodiment.

FIG. 9 is a schematic cross-sectional view of a filter unit of a sixth embodiment.

FIG. 10 is a schematic cross-sectional view of a filter unit of the sixth embodiment.

### DESCRIPTION OF EMBODIMENTS

### First Embodiment

A filter unit, a liquid flow device, and a liquid ejection apparatus of a first embodiment will be described below with reference to the drawings. The liquid ejection apparatus is, for example, an ink-jet type printer that ejects ink, which is an example of liquid, onto a medium such as paper for printing.

In the drawings, a Z-axis represents a direction of gravity and an X-axis and a Y-axis represent directions along a horizontal plane, assuming that a liquid ejection unit 12 is placed on the horizontal plane. The X-axis, the Y-axis, and the Z-axis are orthogonal to one another. In the following description, a direction parallel to the Z-axis is also referred to as a vertical direction Z.

### Liquid Ejection Apparatus

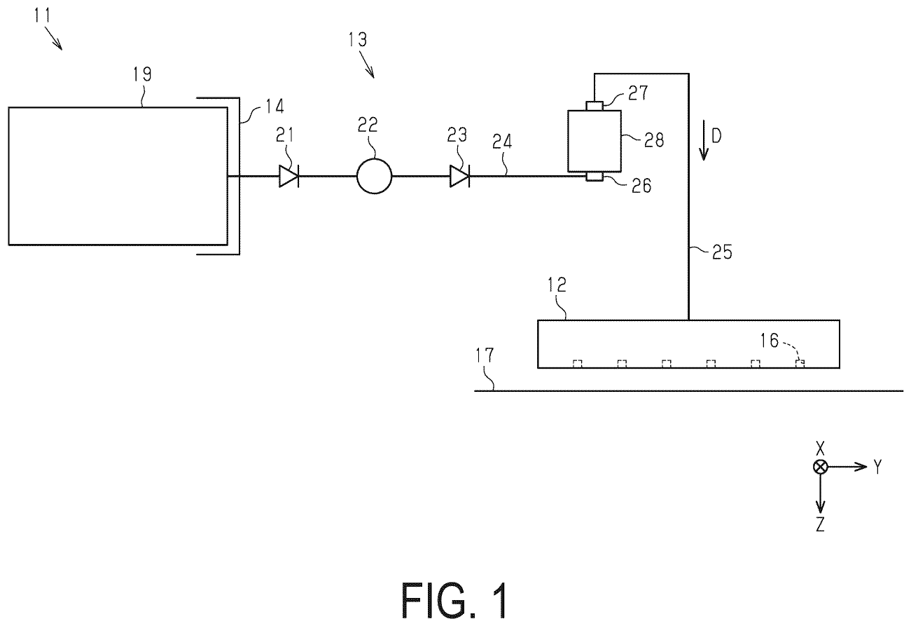

As illustrated in FIG. 1, the liquid ejection apparatus 11 includes a liquid ejection unit 12 and a liquid flow device 13. The liquid ejection apparatus 11 may include an attachment portion 14.

The liquid ejection unit 12 is configured to eject liquid. The liquid ejection unit 12 includes one or more nozzles 16. The liquid ejection unit 12 ejects the liquid from the nozzles 16 to perform printing on a medium 17.

A liquid supply source 19 storing liquid is detachably attached to the attachment portion 14. When the liquid supply source 19 is a tank that can be replenished with liquid, the liquid supply source 19 may be fixed to the attachment portion 14.

### Liquid Flow Device

The liquid flow device 13 supplies liquid, from the liquid supply source 19 attached to the attachment portion 14, to the liquid ejection unit 12. The liquid flow device 13 may include a first one way valve 21, a supply pump 22, and a second one way valve 23. The liquid flow device 13 includes an upstream flow path 24, a downstream flow path 25, an upstream coupling portion 26, a downstream coupling portion 27, and a filter unit 28.

The upstream flow path 24 may be provided with the first one way valve 21, the supply pump 22, and the second one way valve 23. The first one way valve 21 is provided upstream of the supply pump 22 in a supply direction D. The second one way valve 23 is provided downstream of the supply pump 22 in the supply direction D. The first one way valve 21 and the second one way valve 23 enable the liquid to flow toward the downstream in the supply direction D and restrict the flow of the liquid toward the upstream.

The supply pump 22 is provided between the first one way valve 21 and the second one way valve 23. The supply pump 22 is, for example, a diaphragm pump. The supply pump 22 applies a negative pressure to the liquid stored in the liquid supply source 19. Thus, the liquid is led out to the upstream flow path 24. The supply pump 22 pressurizes the liquid led out from the liquid supply source 19, to supply the liquid to the liquid ejection unit 12.

The upstream flow path 24 is coupled to the upstream coupling portion 26. The upstream flow path 24 has a downstream end coupled to the upstream coupling portion 26. The upstream flow path 24 may have an upstream end provided to the attachment portion 14. The upstream end of the upstream flow path 24 may be, for example, a hollow needle that pierces the liquid supply source 19. When the upstream end of the upstream flow path 24 is coupled to the liquid supply source 19 attached to the attachment portion 14, the liquid stored in the liquid supply source 19 can be led out.

The downstream flow path 25 is coupled to the downstream coupling portion 27. The downstream flow path 25 has an upstream end coupled to the downstream coupling portion 27. The downstream flow path 25 has a downstream end coupled to the liquid ejection unit 12.

The upstream coupling portion 26 may be located more on the lower side than the downstream coupling portion 27 in the vertical direction Z.

### Filter Unit

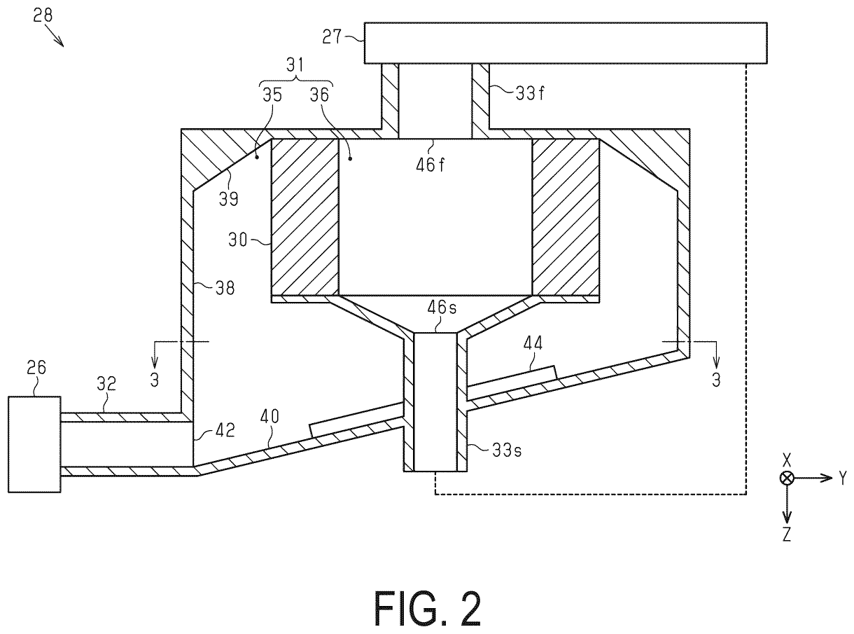

As illustrated in FIG. 2, the filter unit 28 can be detachably attached to the upstream coupling portion 26 and the downstream coupling portion 27. FIG. 2 illustrates the filter unit 28 with an orientation in a state of being attached to the upstream coupling portion 26 and the downstream coupling portion 27.

The filter unit 28 includes a filter 30, a filter chamber 31, an introduction flow path 32, a first lead-out flow path 33f which is an example of a lead-out flow path, and a second lead-out flow path 33s.

The filter 30 filters the liquid. The filter 30 captures foreign matter contained in the liquid. The filter 30 may be a porous body, a nonwoven fabric, or the like. The filter 30 may have a cylindrical shape.

The filter chamber 31 includes a pre-filter chamber 35 and a post-filter chamber 36. The pre-filter chamber 35 and the post-filter chamber 36 are partitioned by the filter 30.

The pre-filter chamber 35 may surround the outside of the filter 30 and the post-filter chamber 36. The pre-filter chamber 35 may have a side surface 38, a top surface 39, and a bottom surface 40. The pre-filter chamber 35 may be located below the upper end of the filter 30. The pre-filter chamber 35 has no space above the filter 30.

The top surface 39 is located below the upper end of the filter 30. The top surface 39 is a flat surface whose end in contact with the filter 30 is located at the highest position. The top surface 39 may be inclined upward from the side surface 38 toward the filter 30.

The side surface 38 may be provided with an introduction port 42. The introduction port 42 is located in a lowermost portion of the pre-filter chamber 35. The introduction port 42 has a lower end in contact with the bottom surface 40.

The bottom surface 40 is inclined upward from the position of the introduction port 42. The bottom surface 40 has an end on the introduction port 42 located at the lowest position. The bottom surface 40 has an end on the side opposite to the introduction port 42 located at the highest position.

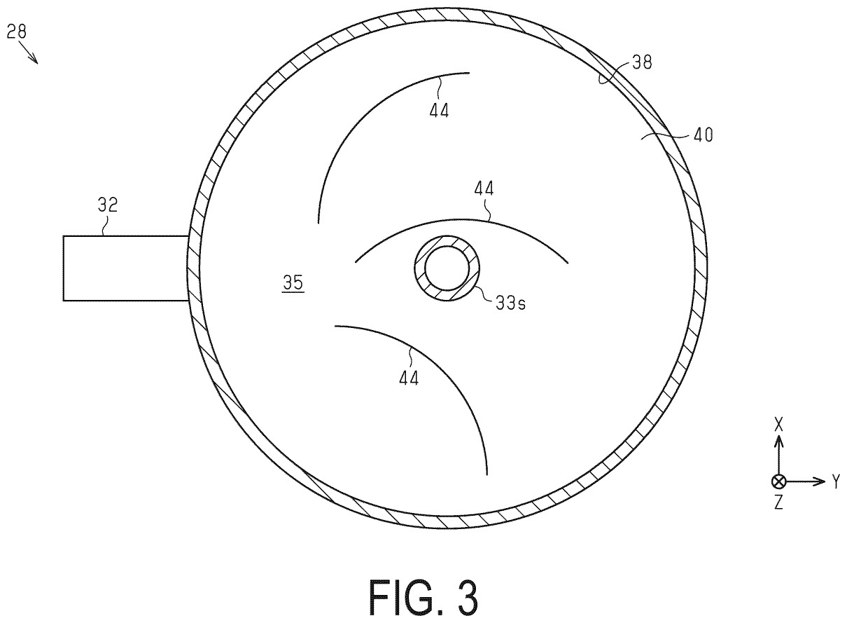

As illustrated in FIGS. 2 and 3, the pre-filter chamber 35 may include a plurality of ribs 44. The plurality of ribs 44 are provided on the bottom surface 40 in the pre-filter chamber 35. The rib 44 may have an arc shape. A distance between ends of the adjacent ribs 44 close to the introduction port 42 may be longer than that between ends thereof far from the introduction port 42.

As illustrated in FIG. 2, the upstream end of the introduction flow path 32 is detachably coupled to the upstream coupling portion 26. The downstream end of the introduction flow path 32 is coupled to the pre-filter chamber 35. With the introduction flow path 32, the liquid is introduced into the pre-filter chamber 35 through the introduction port 42.

The post-filter chamber 36 may be a space inside the filter 30. The post-filter chamber 36 may have a first lead-out port 46f, which is an example of a lead-out port, and a second lead-out port 46s. The first lead-out port 46f is located in the uppermost portion of the post-filter chamber 36. The second lead-out port 46s is provided in a lowermost portion of the post-filter chamber 36.

The downstream end of the first lead-out flow path 33f is detachably coupled to the downstream coupling portion 27. The upstream end of the first lead-out flow path 33f is coupled to the post-filter chamber 36. With the first lead-out flow path 33f, the liquid is led out from the post-filter chamber 36 through the first lead-out port 46f.

The downstream end of the second lead-out flow path 33s is detachably coupled to the downstream coupling portion 27. The upstream end of the second lead-out flow path 33s is coupled to the post-filter chamber 36. With the second lead-out flow path 33s, the liquid is led out from the post-filter chamber 36 through the second lead-out port 46s.

### Operations of First Embodiment

Operations of the present embodiment will be described. As illustrated in FIG. 2, when the filter unit 28 is filled with liquid, the liquid is introduced from the introduction flow path 32 into the pre-filter chamber 35. The liquid level of the liquid rises along the inclined bottom surface 40. When the liquid level rises to the filter 30, the liquid passes through the filter 30 and flows into the post-filter chamber 36.

The upper end of the filter 30 is located above the pre-filter chamber 35. Therefore, before the pre-filter chamber 35 is filled with liquid, the air in the pre-filter chamber 35 comes into contact with the filter 30. The liquid in the pre-filter chamber 35 pushes out the air in the pre-filter chamber 35 as the liquid level rises. The air in the pre-filter chamber 35 passes through the filter 30 and moves to the post-filter chamber 36.

Through the first lead-out flow path 33f, the air in the post-filter chamber 36 is led out before the post-filter chamber 36 is filled with liquid. When the post-filter chamber 36 is filled with liquid, the liquid is led out through the first lead-out flow path 33f.

Also when liquid is supplied to the liquid ejection unit 12, the liquid is introduced into the filter unit 28 from the introduction flow path 32. The liquid introduced into the pre-filter chamber 35 swirls up along the bottom surface 40, with the flow disturbed by the ribs 44. Therefore, the liquid in the pre-filter chamber 35 is stirred by the introduced liquid.

The liquid in the post-filter chamber 36 may be discharged from the first lead-out flow path 33f and the second lead-out flow path 33s. When precipitation occurs in the post-filter chamber 36, low-concentration liquid is led out from the first lead-out flow path 33f, and high-concentration liquid is led out from the second lead-out flow path 33s. The low-concentration liquid and the high-concentration liquid may be mixed and supplied to the liquid ejection unit 12.

### Effects of First Embodiment

Effects of the present embodiment will be described.
(1-1) When the filter unit 28 is filled with liquid, bubbles are likely to remain on the upper side. In this regard, the introduction port 42 is located in a lowermost portion of the pre-filter chamber 35. The liquid introduced into the pre-filter chamber 35 through the introduction port 42, passes through the filter 30 to flow into the post-filter chamber 36, with the liquid level rising along the bottom surface 40 inclined. The first lead-out port 46f is located in the uppermost portion of the post-filter chamber 36. Since the liquid filling can be implemented while discharging the bubbles from the first lead-out port 46f, the bubble dischargeability can be improved.
(1-2) For example, when the pre-filter chamber 35 has a space above the filter 30, bubbles may remain in the space. In this regard, the pre-filter chamber 35 is located below the upper end of the filter 30. Therefore, by eliminating a space where air is likely to remain, remaining of bubbles can be suppressed.
(1-3) The pre-filter chamber 35 has the ribs 44 provided on the bottom surface 40. The ribs 44 block the flow of the liquid introduced into the pre-filter chamber 35. Thus, the ribs 44 disturb the flow of liquid, so that the liquid can be stirred.
(1-4) The bottom surface 40 of the pre-filter chamber 35 is inclined upward from the position of the introduction port 42. Therefore, the liquid that has flowed into the pre-filter chamber 35 through the introduction port 42 is likely to flow upward in the vicinity of the introduction port 42. Therefore, even when liquid with which precipitation is likely to occur with the lapse of time is used, the precipitated liquid can be stirred.

### Second Embodiment

Next, a filter unit of a second embodiment will be described with reference to the drawings. In the present embodiment, the same components as those in the above embodiment are denoted by the same reference numerals, and redundant descriptions thereof are omitted.

### Filter Unit

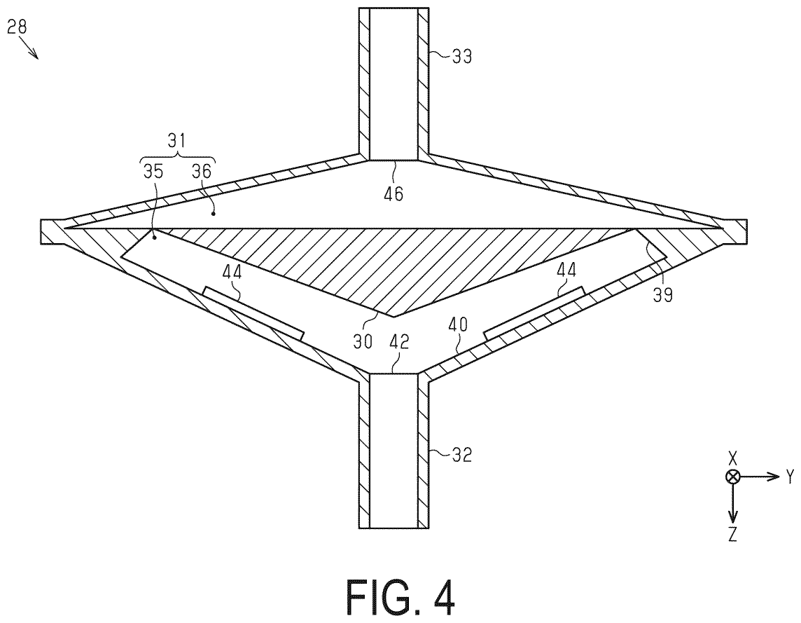

FIG. 4 illustrates the filter unit 28 with an orientation in a state of being attached to the upstream coupling portion 26 and the downstream coupling portion 27.

As illustrated in FIG. 4, the filter unit 28 may include the filter 30, the pre-filter chamber 35, the post-filter chamber 36, the introduction flow path 32, the lead-out flow path 33, and the ribs 44.

The filter 30 may have a conical shape with the apex at the lower end in the vertical direction z.

The pre-filter chamber 35 may be located below the filter 30 and the post-filter chamber 36. The pre-filter chamber 35 may have the top surface 39, the bottom surface 40, and the introduction port 42. The pre-filter chamber 35 is located below the upper end of the filter 30.

The introduction port 42 may open in the bottom surface 40. The introduction port 42 is located in a lowermost portion of the pre-filter chamber 35. The introduction port 42 may be located at the center of the bottom surface 40. The introduction port 42 may be located directly below the apex of the filter 30.

The bottom surface 40 is inclined upward from the position of the introduction port 42. In the bottom surface 40, the introduction port 42 is located at the lowest position. A position of the bottom surface 40 farther from the introduction port 42 is at a higher height.

With the introduction flow path 32, the liquid is introduced into the pre-filter chamber 35 through the introduction port 42.

The post-filter chamber 36 has a lead-out port 46. The lead-out port 46 is located in an uppermost portion of the post-filter chamber 36. With a lead-out flow path 33, the liquid is led out from the post-filter chamber 36 through the lead-out port 46.

### Operations of Second Embodiment

Operations of the present embodiment will be described.

As illustrated in FIG. 4, when the filter unit 28 is filled with liquid, the liquid is introduced from the introduction flow path 32 into the pre-filter chamber 35. The liquid passes through the filter 30 and flows into the post-filter chamber 36.

Through the lead-out flow path 33, the air in the post-filter chamber 36 is led out before the post-filter chamber 36 is filled with liquid. When the post-filter chamber 36 is filled with liquid, the liquid is led out through the lead-out flow path 33. The liquid led out is sent to the liquid ejection unit 12 through the downstream coupling portion 27 and the downstream flow path 25.

### Effects of Second Embodiment

Effects of the present embodiment will be described.
(2-1) The filter 30 has a conical shape. Therefore, even when liquid filling is implemented with the filter unit 28 inclined, it is possible to maintain a state where part of the filter 30 is above the liquid level until the pre-filter chamber 35 is filled with the liquid. Therefore, it is possible to reduce bubbles remaining in the pre-filter chamber 35.

### Third Embodiment

Next, a filter unit of a third embodiment will be described with reference to the drawings. In the present embodiment, the same components as those in the above embodiment are denoted by the same reference numerals, and redundant descriptions thereof are omitted.

### Filter Unit

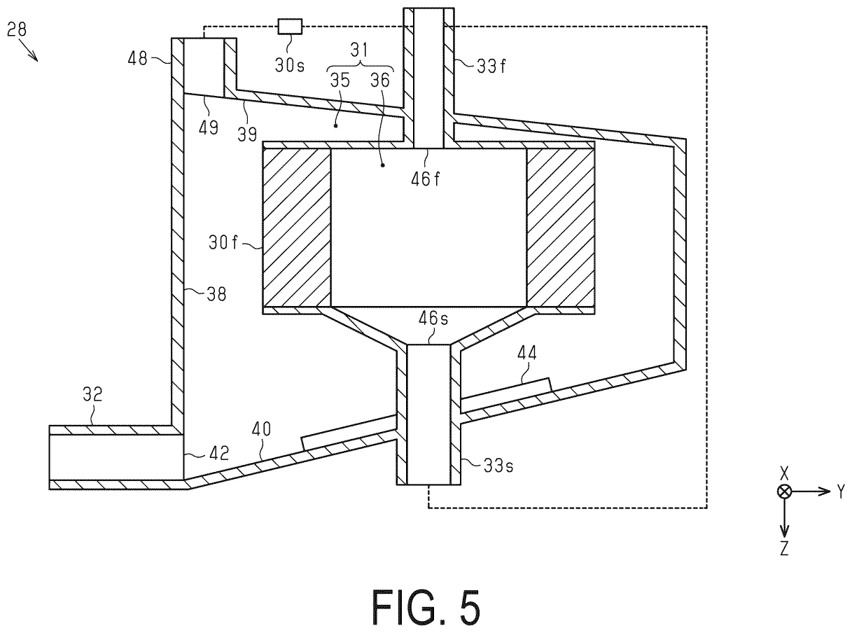

FIG. 5 illustrates the filter unit 28 with an orientation in a state of being attached to the upstream coupling portion 26 and the downstream coupling portion 27.

As illustrated in FIG. 5, the filter unit 28 may include a first filter 30f, which is an example of a filter, the pre-filter chamber 35, the post-filter chamber 36, the introduction flow path 32, the first lead-out flow path 33f, the second lead-out flow path 33s, a bypass flow path 48, and a second filter 30s.

The first filter 30f may have a cylindrical shape. The first filter 30f partitions between the pre-filter chamber 35 and the post-filter chamber 36.

The top surface 39 may be located above the first filter 30f. The top surface 39 may be provided with a bypass port 49. The bypass port 49 is located in an uppermost portion of the pre-filter chamber 35. The top surface 39 is inclined downward from the position of the bypass port 49.

The bypass flow path 48 couples the pre-filter chamber 35 with the first lead-out flow path 33f. The upstream end of the bypass flow path 48 is coupled to the bypass port 49. The downstream end of the bypass flow path 48 is coupled to the first lead-out flow path 33f. With the bypass flow path 48, the liquid is led out from the pre-filter chamber 35 via the bypass port 49. The bypass flow path 48 may be provided with the second filter 30s. The second filter 30s is located above the first filter 30f.

The diameter of the first lead-out flow path 33f may be smaller than the diameter of the second lead-out flow path 33s. The second lead-out flow path 33s may couple the post-filter chamber 36 with the first lead-out flow path 33f. The downstream end of the second lead-out flow path 33s may be coupled to the first lead-out flow path 33f. With the second lead-out flow path 33s, the liquid led out from the post-filter chamber 36 joins the first lead-out flow path 33f.

### Operations of Third Embodiment

Operations of the present embodiment will be described.

As illustrated in FIG. 5, when the filter unit 28 is filled with liquid, the liquid is introduced from the introduction flow path 32 into the pre-filter chamber 35. When liquid touches the first filter 30f, the first filter 30f absorbs the liquid. When the first filter 30f has excellent absorbency, the speed at which the first filter 30f absorbs the liquid may overwhelm the speed at which the liquid level in the pre-filter chamber 35 rises. If the entire first filter 30f becomes wet before the pre-filter chamber 35 is filled with liquid, air cannot be discharged through the first filter 30f.

When the entire first filter 30f becomes wet, the air in the pre-filter chamber 35 is discharged through the bypass flow path 48. When the pre-filter chamber 35 is filled with liquid, the liquid flows into the bypass flow path 48. The liquid that has flowed into the bypass flow path 48 is sent to the liquid ejection unit 12 through the second filter 30s, the first lead-out flow path 33f, the downstream coupling portion 27, and the downstream flow path 25.

### Effects of Third Embodiment

Effects of the present embodiment will be described.
(3-1) For example, when the first filter 30f features high wettability and strong capillary force, the rising speed of the liquid absorbed in the first filter 30f may overwhelm the rising speed of the liquid level. The gas easily passes through the first filter 30f unwetted, but is difficult to pass through the first filter 30f wet. Therefore, when the first filter 30f with high wettability is used, bubbles are likely to remain in the pre-filter chamber 35. In this regard, the bypass flow path 48 is coupled to the uppermost portion of the pre-filter chamber 35. With the bypass flow path 48 the bubbles in the pre-filter chamber 35 can be discharged, whereby the bubble dischargeability can be improved. The liquid flowing through the bypass flow path 48 passes through the second filter 30s and merges with the first lead-out flow path 33f. Therefore, the liquid flowing through the bypass flow path 48 does not need to be discarded and can be used.
(3-2) The liquid in the post-filter chamber 36 is led out through the first lead-out flow path 33f and the second lead-out flow path 33s. With the first lead-out flow path 33f, the liquid is led out from the first lead-out port 46f located in the uppermost portion of the post-filter chamber 36. With the second lead-out flow path 33s, the liquid is led out from the second lead-out port 46s located in the lowermost portion of the post-filter chamber 36. The second lead-out flow path 33s merges with the first lead-out flow path 33f. Therefore, even when precipitation occurs in the post-filter chamber 36, the influence of the precipitation can be reduced, because low-concentration liquid in the upper portion of the post-filter chamber 36 and high-concentration liquid in the lower portion of the post-filter chamber 36 are led out and mixed.
(3-3) When the diameters of the first lead-out flow path 33f and the second lead-out flow path 33s are the same, the liquid is likely to flow toward the first lead-out flow path 33f due to the influence of the arrangement relationship. In this regard, the first lead-out flow path 33f has a smaller diameter than the second lead-out flow path 33s. Therefore, flow of the liquid toward the second lead-out flow path 33s can be facilitated.

### Fourth Embodiment

Next, a filter unit of a fourth embodiment will be described with reference to the drawings. In the present embodiment, the same components as those in the above embodiment are denoted by the same reference numerals, and redundant descriptions thereof are omitted.

### Filter Unit

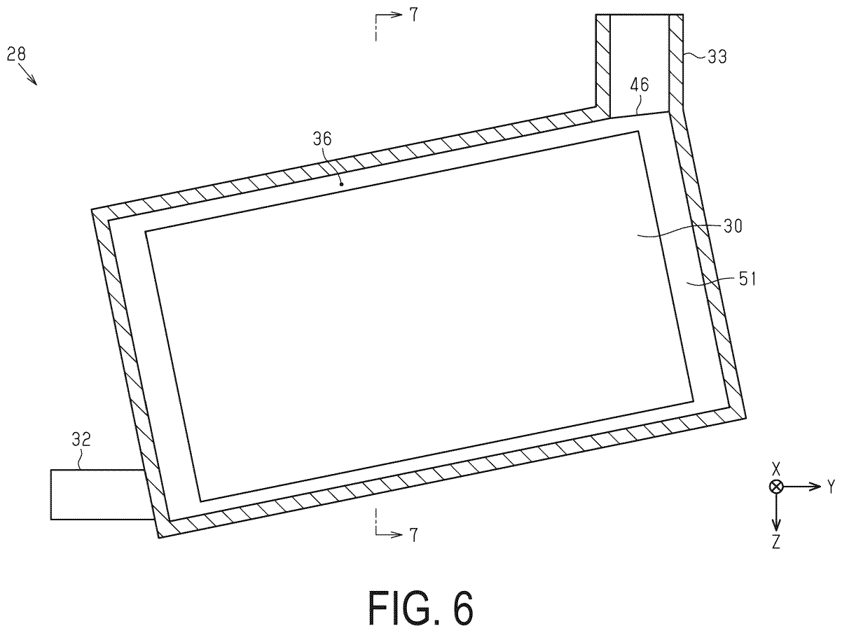

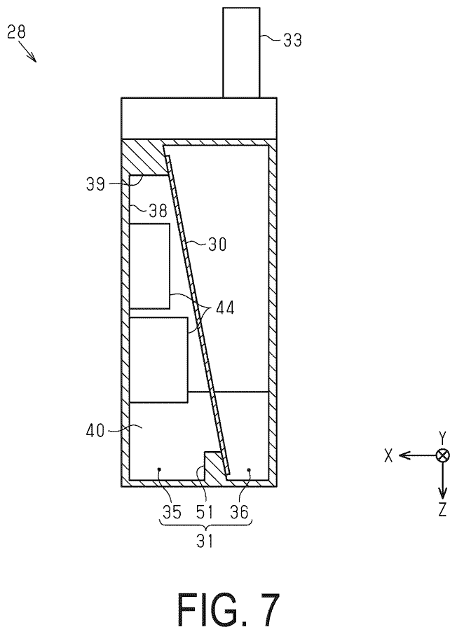

FIG. 6 and FIG. 7 illustrate the filter unit 28 with an orientation in a state of being attached to the upstream coupling portion 26 and the downstream coupling portion 27.

As illustrated in FIG. 6 and FIG. 7, the filter unit 28 may include the filter 30, the pre-filter chamber 35, the post-filter chamber 36, the introduction flow path 32, the lead-out flow path 33, and the ribs 44.

The filter chamber 31 has a partitioning wall 51. The partitioning wall 51 partitions between the pre-filter chamber 35 and the post-filter chamber 36. The pre-filter chamber 35 and the post-filter chamber 36 may be provided side by side in the horizontal direction.

As illustrated in FIG. 7, the partitioning wall 51 may be inclined with respect to the vertical direction Z to make the space above the pre-filter chamber 35 smaller than the space below the pre-filter chamber 35. The distance between the upper end of the side surface 38 and the filter 30 is smaller than the distance between the lower end of the side surface 38 and the filter 30. The area of the top surface 39 is smaller than the area of the bottom surface 40. The filter 30 is provided in an opening of the partitioning wall 51.

The side surface 38 may be provided with the plurality of ribs 44. The plurality of ribs 44 may have different sizes. For example, the ribs 44 located on the upper side may be smaller than the ribs 44 located on the lower side. The ribs 44 do not come into contact with the filter 30.

### Operations of Fourth Embodiment

Operations of the present embodiment will be described.

As illustrated in FIG. 6 and FIG. 7, when the filter unit 28 is filled with liquid, the liquid is introduced from the introduction flow path 32 into the pre-filter chamber 35. The liquid passes through the filter 30 and flows into the post-filter chamber 36. The liquid in the post-filter chamber 36 is discharged from the lead-out flow path 33.

### Effects of Fourth Embodiment

Effects of the present embodiment will be described.
(4-1) Bubbles in the pre-filter chamber 35 are likely to accumulate in the upper space. In this regard, the upper space of the pre-filter chamber 35 is smaller than the lower space thereof. Therefore, it is possible to reduce bubbles remaining in the pre-filter chamber 35.
(4-2) The pre-filter chamber 35 includes the ribs 44 provided on the side surface 38. The ribs 44 block the flow of the liquid introduced into the pre-filter chamber 35. Thus, the ribs 44 disturb the flow of liquid, so that the liquid can be stirred.

### Fifth Embodiment

Next, a filter unit of a fifth embodiment will be described with reference to the drawings. In the present embodiment, the same components as those in the above embodiment are denoted by the same reference numerals, and redundant descriptions thereof are omitted.

### Filter Unit

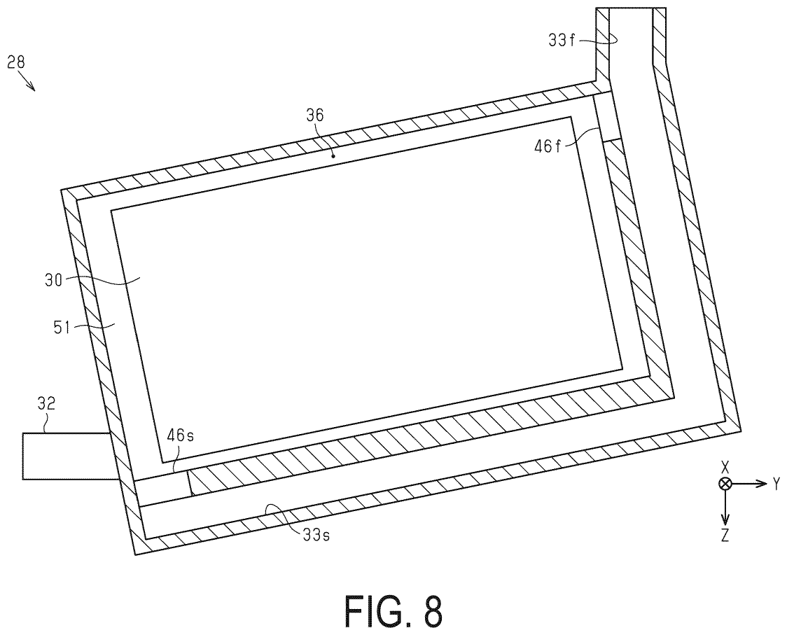

FIG. 8 illustrates the filter unit 28 with an orientation in a state of being attached to the upstream coupling portion 26 and the downstream coupling portion 27.

As illustrated in FIG. 8, the filter unit 28 may include the filter 30, as well as the pre-filter chamber 35, the post-filter chamber 36, the introduction flow path 32, the first lead-out flow path 33f, and the second lead-out flow path 33s not illustrated in FIG. 8.

The first lead-out port 46f is located in the uppermost portion of the post-filter chamber 36. The second lead-out port 46s is provided in a lowermost portion of the post-filter chamber 36.

With the first lead-out flow path 33f, the liquid is led out from the post-filter chamber 36 through the first lead- out port 46f. The first lead-out flow path 33f is a flow path from the first lead-out port 46f to the downstream coupling portion 27.

With the second lead-out flow path 33s, the liquid is led out from the post-filter chamber 36 through the second lead-out port 46s. The second lead-out flow path 33s may be provided along the circumference of the post-filter chamber 36. The second lead-out flow path 33s merges with the first lead-out flow path 33f. The second lead-out flow path 33s is a flow path from the second lead-out port 46s to the first lead-out port 46f.

### Operations of Fifth Embodiment

Operations of the present embodiment will be described.

When the filter unit 28 is filled with liquid, the liquid level of the liquid that has passed through the filter 30 gradually rises. The second lead-out port 46s is provided in a lowermost portion of the post-filter chamber 36. The liquid in the post-filter chamber 36 flows into the second lead-out flow path 33s. The liquid level in the second lead-out flow path 33s rises with the liquid level in the post-filter chamber 36. Therefore, when the liquid level in the post-filter chamber 36 rises to the first lead-out port 46f, the second lead-out flow path 33s is filled with the liquid.

Through the first lead-out flow path 33f, the air in the post-filter chamber 36 and the second lead-out flow path 33s is led out before the post-filter chamber 36 is filled with liquid. When the post-filter chamber 36 is filled with liquid, the liquid is led out through the first lead-out flow path 33f.

When the liquid precipitated in the post-filter chamber 36 is supplied to the liquid ejection unit 12, low-concentration liquid is led out from the first lead-out flow path 33f, and high-concentration liquid is led out from the second lead-out flow path 33s. The low-concentration liquid and the high-concentration liquid may be mixed and supplied to the liquid ejection unit 12.

### Sixth Embodiment

Next, a filter unit of a sixth embodiment will be described with reference to the drawings. In the present embodiment, the same components as those in the above embodiment are denoted by the same reference numerals, and redundant descriptions thereof are omitted.

### Filter Unit

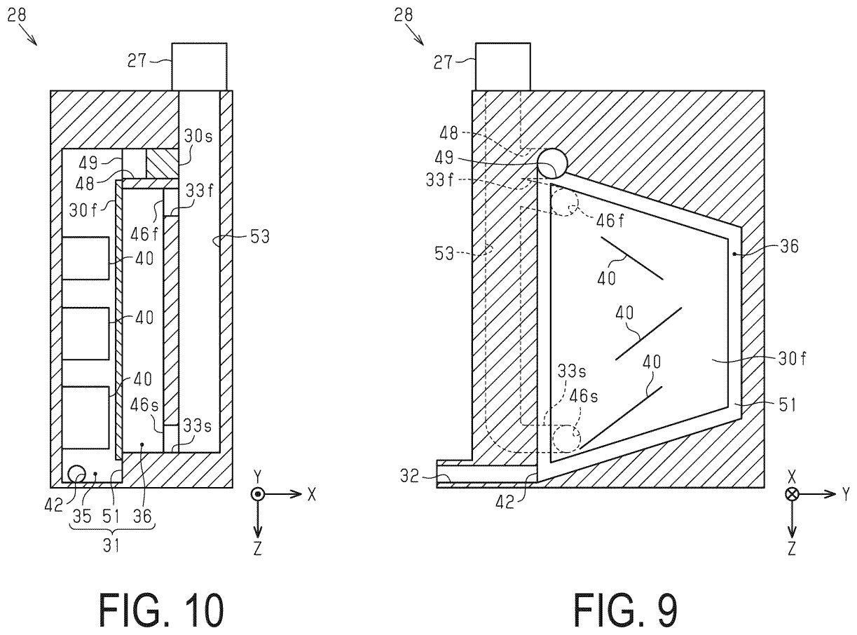

FIG. 9 and FIG. 10 illustrate the filter unit 28 with an orientation in a state of being attached to the upstream coupling portion 26 and the downstream coupling portion 27.

As illustrated in FIG. 9 and FIG. 10, the filter unit 28 includes the first filter 30f, the pre-filter chamber 35, the post-filter chamber 36, the introduction flow path 32, the first lead-out flow path 33f, the second lead-out flow path 33s, a bypass flow path 48, and a second filter 30s.

The filter unit 28 includes a merging flow path 53. The merging flow path 53 leads to the downstream coupling portion 27. The first lead-out flow path 33f, the second lead-out flow path 33s, and the bypass flow path 48 merge into the merging flow path 53. The diameter of the merging flow path 53 is larger than the diameter of each of the first lead-out flow path 33f, the second lead-out flow path 33s, and the bypass flow path 48. Among the diameters of the first lead-out flow path 33f, the second lead-out flow path 33s, the bypass flow path 48, and the merging flow path 53, the diameter of the merging flow path 53 is the largest.

### Operations of Sixth Embodiment

Operations of the present embodiment will be described.

When the filter unit 28 is filled with liquid, if the speed at which the liquid level in the merging flow path 53 rises is higher than the speed at which the liquid level in the pre-filter chamber 35 rises, there is a concern that the second filter 30s may become wet before the bubbles are discharged from the bypass flow path 48. In this regard, the diameter of the merging flow path 53 is larger than the diameter of each of the first lead-out flow path 33f, the second lead-out flow path 33s, and the bypass flow path 48. Therefore, the speed at which the liquid level in the merging flow path 53 rises can be reduced.

### Effects of Sixth Embodiment

Effects of the present embodiment will be described.
(6-1) The diameter of the merging flow path 53 is larger than the diameters of the first lead-out flow path 33f, the second lead-out flow path 33s, and the bypass flow path 48. Therefore, it is possible to efficiently mix the liquids sent from the first lead-out flow path 33f, the second lead-out flow path 33s, and the bypass flow path 48.

### Modifications

The embodiments may be modified as follows for implementation. The embodiments and modifications described below may be combined for implementation insofar as they are not technically inconsistent.
The filter unit 28 may not include the ribs 44. The filter unit 28 may have ribs 44 provided on both the bottom surface 40 and the side surface 38. The top surface 39 may be provided with the ribs 44. The partitioning wall 51 may be provided with the ribs 44.
At least two of the first lead-out flow path 33f, the second lead-out flow path 33s, the bypass flow path 48, and the merging flow path 53 may have the same diameter. The diameter of the merging flow path 53 may be smaller than the diameter of at least one of the first lead-out flow path 33f, the second lead-out flow path 33s, and the bypass flow path 48.
The first lead-out flow path 33f and the second lead-out flow path 33s may have the same diameter. The diameter of the second lead-out flow path 33s may be smaller than the diameter of the first lead-out flow path 33f.
The partitioning wall 51 may be provided along the vertical direction Z.
The pre-filter chamber 35 may be located above the upper end of the filter 30 or the first filter 30f
The filter unit 28 may be fixed to at least one of the upstream coupling portion 26 and the downstream coupling portion 27.
The liquid flow device 13 may be provided separately from the liquid ejection apparatus 11.
The liquid ejection apparatus 11 may be a liquid ejection apparatus that sprays or ejects liquid other than ink. The state of the liquid ejected from the liquid ejection apparatus in a form of a minute amount of droplet is assumed to include a particulate form, a teardrop form, and a thread like extending form. This liquid may be any material that can be ejected from the liquid ejection apparatus. For example, the liquid may be any material in a state of being in a liquid phase, and is assumed to include a liquid body having high or low viscosity, as well as a fluid body such as sol, gel water, other inorganic solvents, an organic solvent, a solution, a liquid resin, a liquid metal, and a metal melt. The liquid includes not only liquid as a single state of the substance, but also includes particles of a functional material made of a solid such as pigment or metal particles dissolved in a solvent, dispersed or mixed in a solvent, and the like. Typical examples of the liquid include the ink and the liquid crystal as described in the above embodiment. The ink here includes various liquid compositions such as general aqueous ink and solvent ink, gel ink, and hot-melt ink. Examples of the liquid ejection apparatus include an apparatus that ejects liquid including, in a dispersed or dissolved form, a material such as an electrode material and a color material used in manufacture of liquid crystal displays, electroluminescent displays, surface emitting displays, color filters and the like. The liquid ejection apparatus may be an apparatus ejecting bioorganic substances used for biochip manufacturing, an apparatus used as a precision pipette and ejecting liquid to be a sample, a printing apparatus, a micro dispenser, or the like. The liquid ejection apparatus may be an apparatus ejecting lubricant to a precision machine such as a clock or a camera in a pinpoint manner, or an apparatus ejecting transparent resin liquid such as ultraviolet cure resin or the like on a substrate for forming a tiny hemispherical lens, optical lens, or the like used for an optical communication element and the like. The liquid ejection apparatus may be an apparatus ejecting etching liquid such as an acid or an alkali for etching a substrate or the like.

### Definition

A representation “at least one” as used herein means “one or more” of desired options. As an example, a representation “at least one” as used herein means “only one option” or “both of two options” when the number of options is two. As another example, the representation “at least one” as used herein means “only one option”, “any combination of two options”, or “any combination of three or more options” when the number of options is three or more.

### Supplementary Note

The following is a description of the technical ideas and their effects that can be grasped from the above-described embodiments and modifications.

(A) A filter unit is attachable to and detachable from an upstream coupling portion and a downstream coupling portion located above the upstream coupling portion in a vertical direction, an includes: a filter configured to filter liquid; a filter chamber including a pre-filter chamber and a post-filter chamber that are partitioned by the filter; an introduction flow path through which the liquid is introduced into the pre-filter chamber through an introduction port; and a lead-out flow path through which the liquid is led out from the post-filter chamber through a lead-out port, wherein when the filter unit is in a state of being attached to the upstream coupling portion and the downstream coupling portion, the introduction port is located in a lowermost portion of the pre-filter chamber, the lead-out port is located in an uppermost portion of the post-filter chamber, and the pre-filter chamber has a bottom surface inclined upward from the location of the introduction port.

When the filter unit is filled with liquid, bubbles are likely to remain on the upper side. In this regard, according to the configuration, the introduction port is located in a lowermost portion of the pre-filter chamber. The liquid introduced into the pre-filter chamber through the introduction port, passes through the filter to flow into the post-filter chamber, with the liquid level rising along the bottom surface inclined. The lead-out port is located in the uppermost portion of the post-filter chamber. Since the liquid filling can be implemented while discharging the bubbles from the lead-out port, the bubble dischargeability can be improved.

(B) In the filter unit according to (A), the pre-filter chamber may be located below an upper end of the filter.

For example, when the pre-filter chamber has a space above the filter, bubbles may remain in the space. In this regard, according to the configuration, the pre-filter chamber is located below the upper end of the filter. Therefore, by eliminating a space where air is likely to remain, remaining of bubbles can be suppressed.

(C) In the filter unit according to (A) or (B), when the filter is defined as a first filter, the filter unit may further include a second filter, and a bypass flow path coupling the pre-filter chamber with the lead-out flow path, the bypass flow path may be coupled to a bypass port located in an uppermost portion of the pre-filter chamber, and the second filter may be provided in the bypass flow path.

For example, when the filter features high wettability and strong capillary force, the rising speed of the liquid absorbed in the filter may overwhelm the rising speed of the liquid level. The gas easily passes through the filter unwetted, but is difficult to pass through the filter wet. Therefore, when the filter which is easily wet is used, bubbles are likely to remain in the pre-filter chamber. In this regard, according to the configuration, the bypass flow path is coupled to the uppermost portion of the pre-filter chamber. With the bypass flow path the bubbles in the pre-filter chamber can be discharged, whereby the bubble dischargeability can be improved. The liquid flowing through the bypass flow path passes through the second filter and merges with the lead-out flow path. Therefore, the liquid flowing through the bypass flow path does not need to be discarded and can be used.

(D) In the filter unit according to any one of (A) to (C), the filter chamber may include a partitioning wall partitioning between the pre-filter chamber and the post-filter chamber, the partitioning wall may be provided to be inclined with respect to the vertical direction to make a space above the pre-filter chamber smaller than a space below the pre-filter chamber, and the filter may be provided in an opening of the partition wall.

The bubbles in the pre-filter chamber are likely to accumulate in the upper space. In this regard, according to the configuration, the upper space of the pre-filter chamber is smaller than the lower space thereof. Therefore, it is possible to reduce bubbles remaining in the pre-filter chamber.

(E) In the filter unit according to any one of (A) to (D), when the lead-out port is defined as a first lead-out port and the lead-out flow path is defined as a first lead-out flow path, the filter unit may further include a second lead-out flow path through which the liquid is led out from the post-filter chamber, and with the second lead-out flow path, the liquid led out from the post-filter chamber through the second lead-out port provided in a lowermost portion of the post-filter chamber may join the first lead-out flow path.

According to the configuration, the liquid in the post-filter chamber is led out through the first lead-out flow path and the second lead-out flow path. With the first lead-out flow path, the liquid is led out from the first lead-out port located in the uppermost portion of the post-filter chamber. With the second lead-out flow path, the liquid is led out from the second lead-out port located in the lowermost portion of the post-filter chamber. The second lead-out flow path merges with the first lead-out flow path. Therefore, even when precipitation occurs in the post-filter chamber, the influence of the precipitation can be reduced, because low-concentration liquid in the upper portion of the post-filter chamber and high-concentration liquid in the lower portion of the post-filter chamber are led out and mixed.

(F) In the filter unit according to (E), a diameter of the first lead-out flow path may be smaller than a diameter of the second lead-out flow path.

When the diameters of the first lead-out flow path and the second lead-out flow path are the same, the liquid is likely to flow toward the first lead-out flow path due to the influence of the arrangement relationship. In this regard, according to the configuration, the first lead-out flow path has a smaller diameter than the second lead-out flow path. Therefore, flow of the liquid toward the second lead-out flow path can be facilitated.

(G) In the filter unit according to (E), when the filter is defined as a first filter, the filter unit may further include a second filter, and a bypass flow path coupling the pre-filter chamber with the first lead-out flow path, the bypass flow path may be coupled to a bypass port located in an uppermost portion of the pre-filter chamber, and the second filter may be provided in the bypass flow path.

According to the configuration, an effect the same as or similar to that of the above filter unit may be achieved.

(H) In the filter unit according to (E), when the filter is defined as a first filter, the filter unit may further include a merging flow path coupled to the downstream coupling portion, a bypass flow path connected to a bypass port located in an uppermost portion of the pre-filter chamber, and a second filter provided in the bypass flow path, the first lead-out flow path, the second lead-out flow path, and the bypass flow path may merge into the merging flow path, and among diameters of the first lead-out flow path, the second lead-out flow path, the bypass flow path, and the merging flow path, a diameter of the merging flow path may be largest.

According to the configuration, the diameter of the merging flow path is larger than the diameters of the first lead-out flow path, the second lead-out flow path, and the bypass flow path. Therefore, it is possible to efficiently mix the liquids sent from the first lead-out flow path, the second lead-out flow path, and the bypass flow path.

(I) In the filter unit according to any one of (A) to (H), the pre-filter chamber may have a plurality of ribs provided on the bottom surface.

According to the configuration, the pre-filter chamber has the ribs provided on the bottom surface. The ribs blocks the flow of the liquid introduced into the pre-filter chamber. Thus, the ribs disturb the flow of liquid, so that the liquid can be stirred.

(J) In the filter unit according to any one of (A) to (I), the pre-filter chamber may have a plurality of ribs provided on a side surface.

According to the configuration, the pre-filter chamber has the ribs provided on the side surface. The ribs blocks the flow of the liquid introduced into the pre-filter chamber. Thus, the ribs disturb the flow of liquid, so that the liquid can be stirred.

(K) A liquid flow device includes: the filter unit according to (A) to (J); the upstream coupling portion; the downstream coupling portion; an upstream flow path coupled to the upstream coupling portion; and a downstream flow path coupled to the downstream coupling portion.

According to the configuration, an effect the same as or similar to that of the above filter unit can be achieved.

(L) A liquid ejection apparatus includes: the liquid flow device according to (K); and a liquid ejection unit configured to eject liquid.

According to the configuration, an effect the same as or similar to that of the above filter unit can be achieved.

What is claimed is:

1. A filter unit attachable to and detachable from an upstream coupling portion and a downstream coupling portion located above the upstream coupling portion in a vertical direction, the filter unit comprising:
a filter configured to filter liquid;
a filter chamber including a pre-filter chamber and a post-filter chamber that are partitioned by the filter;
an introduction flow path through which the liquid is introduced into the pre-filter chamber through an introduction port; and
a lead-out flow path through which the liquid is led out from the post-filter chamber through a lead-out port, wherein
when the filter unit is in a state of being attached to the upstream coupling portion and the downstream coupling portion,
the introduction port is located in a lowermost portion of the pre-filter chamber,
the lead-out port is located in an uppermost portion of the post-filter chamber, and
the pre-filter chamber has a bottom surface inclined upward from the location of the introduction port.

2. The filter unit according to claim 1, wherein the pre-filter chamber is located below an upper end of the filter

3. The filter unit according to claim 1, wherein
when the filter is defined as a first filter,
the filter unit further comprises
a second filter, and
a bypass flow path coupling the pre-filter chamber with the lead-out flow path,
the bypass flow path is coupled to a bypass port located in an uppermost portion of the pre-filter chamber, and
the second filter is provided in the bypass flow path.

4. The filter unit according to claim 1, wherein
the filter chamber includes a partition wall partitioning between the pre-filter chamber and the post-filter chamber,
the partition wall is provided to be inclined with respect to the vertical direction to make a space above the pre-filter chamber smaller than a space below the pre-filter chamber, and
the filter is provided in an opening of the partition wall.

5. The filter unit according to claim 1, wherein
when the lead-out port is defined as a first lead-out port and the lead-out flow path is defined as a first lead-out flow path,
the filter unit further comprises a second lead-out flow path through which the liquid is led out from the post-filter chamber, and
with the second lead-out flow path, the liquid led out from the post-filter chamber through the second lead-out port provided in a lowermost portion of the post-filter chamber joins the first lead-out flow path.

6. The filter unit according to claim 5, wherein a diameter of the first lead-out flow path is smaller than a diameter of the second lead-out flow path.

7. The filter unit according to claim 5, wherein
when the filter is defined as a first filter,
the filter unit further comprises
a second filter, and
a bypass flow path coupling the pre-filter chamber with the first lead-out flow path,
the bypass flow path is coupled to a bypass port located in an uppermost portion of the pre-filter chamber, and
the second filter is provided in the bypass flow path.

8. The filter unit according to claim 5, wherein
when the filter is defined as a first filter,
the filter unit further comprises
a merging flow path coupled to the downstream coupling portion,
a bypass flow path connected to a bypass port located in an uppermost portion of the pre-filter chamber, and
a second filter provided in the bypass flow path,
the first lead-out flow path, the second lead-out flow path, and the bypass flow path merge into the merging flow path, and
among diameters of the first lead-out flow path, the second lead-out flow path, the bypass flow path, and the merging flow path, a diameter of the merging flow path is largest.

9. The filter unit according to claim 1, wherein the pre-filter chamber has a plurality of ribs provided on the bottom surface.

10. The filter unit according to claim 1, wherein the pre-filter chamber has a plurality of ribs provided on a side surface.

11. A liquid flow device comprising:
the filter unit according to claim 1;
the upstream coupling portion;
the downstream coupling portion;
an upstream flow path coupled to the upstream coupling portion; and
a downstream flow path coupled to the downstream coupling portion.

12. A liquid ejection apparatus comprising:
the liquid flow device according to claim 11; and
a liquid ejection unit configured to eject liquid.
